(19) United States
(12) Patent Application Publication
(10) Pub. No.: US 2019/0070766 A1
(43) Pub. Date: Mar. 7, 2019

(54) METHOD AND MACHINE FOR BLOW MOULDING RECEPTACLES FROM BLANKS

(71) Applicant: Serac group, LA FERTE BERNARD (FR)

(72) Inventor: André Jean-Jacques GRAFFIN, Chicago, IL (US)

(21) Appl. No.: 16/120,849

(22) Filed: Sep. 4, 2018

(30) Foreign Application Priority Data
Sep. 1, 2017 (FR) 17 58120

(51) Int. Cl. B29C 49/02; B29C 49/64

(52) U.S. Cl. CPC B29C 49/02; B29L 2031/712; B29C 49/6418

(57) ABSTRACT

A method for manufacturing receptacles, comprising the steps of:
heating tubes separate from each other, each tube being obtained by shaping at least one blank as a tube in order to have two edges of the blank facing each other and fixing the two facing edges to each other;
introducing each tube into a mould and blowing a gas therein in order to form the receptacle.

A machine for implementing this method.

The present invention relates to the field of packaging and more particularly the manufacture of receptacles.

### PRIOR ART

A large number of receptacles are manufactured by blow moulding. There exist two major blow-moulding methods, namely injection blow moulding and extrusion blow moulding.

In the first method, a preform is heated and disposed in a mould having a cavity to the shape of the receptacle before pressurised air is introduced into the preform in order to inflate it and press the thus deformed material of the preform against the wall of the mould. The preform is produced by injection and generally is in the form of a specimen provided with a threaded spout that will without modification form the spout of the receptacle. The use of a mould for manufacturing the preform is constraining and makes this method relatively expensive.

In the second method, a tube of thermoplastic material is extruded continuously. A mould having a cavity to the shape of the receptacle is closed on the bottom part of the tube before pressurised air is introduced into said bottom part in order to inflate it and press the thus deformed wall of the tube against the wall defining the cavity of the mould. Such a method allows great productivity and can be implemented by means of a relatively simple machine.

One drawback of these methods is that they do not allow the manufacture of receptacles having a multilayer wall. Furthermore, the decoration of the receptacle must necessarily be carried out during an additional operation.

To remedy these drawbacks, a method has been envisaged for manufacturing receptacles from a strip payed out from a reel. The method comprises the steps of:
conforming the strip as a tube by winding it around an axis substantially perpendicular to an axis of the reel so as to bring two edges of the strip against each other;
welding the two edges one on the other;
heating the tube;
disposing the tube in the mould and introducing air into the tube in order to deform and press the wall of the tube against the wall of the mould.

This method is implemented by means of a receptacle-manufacturing machine comprising successively, in a vertical arrangement, a station for paying out a strip from a reel having a horizontal central axis, a member for shaping the strip as a tube about a vertical direction in order to bring two edges of the end portion facing each other, a tool for welding the two edges, a member for heating the tube, a mould for accepting the heated tube and a device for blowing air into the tube.

The mould is in two parts which, in closing on each other, separate the portion of the tube receiving in the mould from the remainder of the tube.

This machine has many advantages but is difficult to set and to adjust in order to obtain a high manufacturing rate.

In particular, for the wall of the tube to deform sufficiently to match the cavity of the mould, it is important for the temperature of the material constituting the tube to reach a temperature allowing plastic deformation thereof. However, for the material to be able to have reached this temperature when the tube is introduced into the mould, the material must be subjected to relatively lengthy heating, and in any case longer than the other steps of the method. As the speed of travel of the strip is imposed, the heating must be carried out over a relatively long length of the strip, which contributes to distancing the blowing station from the tube-shaping station, requiring a structure that in its height takes up a relatively large amount of space in the machine.

In addition, the blowing device comprises a rod around which the tube is formed and which extends in the tube from the shaper into the mould. The blowing air captive inside the blowing rod opposite the heating member increases in temperature, which is a handicap for the rapid cooling of the receptacle once blown.

### SUBJECT MATTER OF THE INVENTION

One aim of the invention is to provide a means for simplifying the manufacture of receptacles and making it more reliable.

### BRIEF DISCLOSURE OF THE INVENTION

According to the invention, a method for manufacturing receptacles is provided, comprising the steps of:
heating tubes separate from each other, each tube being obtained by shaping at least one blank as a tube in order to have two edges of the blank facing each other and fixing the two facing edges to each other;
introducing each tube into a mould and blowing a gas therein in order to form the receptacle.

Blank means here more particularly a flexible sheet or portion of flexible sheet able to be shaped.

Thus the tubes, each arranged for forming a single receptacle, are separated from each other as they enter the heating member so that each tube forms a preform, the heating of which can be carried out independently of the previous steps, that is to say the duration of the heating is not imposed by the previous steps. This method also offers freedom of angular orientation of the tube around its axis with respect to the mould.

Advantageously, the shaping is carried out by winding the blank around a mandrel.

This shaping method facilitates the winding of the blank in order to form the tube. The risk of the external surface of the strip being damaged during the shaping of the tube is also limited, which is particularly useful when said external surface carries a decoration.

Advantageously also, the blank is a portion of a strip paid out from a reel having a central axis.

This facilitates the supply to the machine, a large quantity of blanks being able to be formed with a reel. The reel is also relatively easy to handle.

Furthermore, the previously known method of manufacturing receptacles from a strip assumes deforming the strip around the axis of the reel (in order to pay it out) and then to deform it around an axis perpendicular to the axis of the reel (in order to wind it so as to form the tube). This double deformation in different directions is tricky to achieve and gives rise to tensions in the strip. In order to limit these tensions, the shaping as a tube is carried out in a position separated from the reel, there also imposing a great height of the machine.

Preferably, the shaping of the tube is carried out so that the tube has a central axis aligned with the width of the strip.

Thus, in this version of the invention, the winding axis of the tube is parallel to the axis of the reel so that winding the strip to form the tube is relatively easy.

Another subject matter of the invention is a machine for manufacturing receptacles, arranged for implementing the method according to the invention, the machine comprising successively:
a station forming tubes from at least one blank, with a member for winding a blank on itself around a winding axis in order to bring two edges of the blank facing each other, and a tool for welding the two edges;
a member for heating the tubes;
a blowing station with at least one mould for accepting the heated tubes and a device for blowing gas into each tube; and
a member for transporting tubes between the tube-formation station and the blowing station, and in the heating member.

This machine has a relative simple structure and allows reliable implementation of the shaping as a tube.

Other features and advantages of the invention will emerge from a reading of the following description of particular non-limitative embodiments of the invention.

### BRIEF DESCRIPTION OF THE FIGURES

Reference will be made to the accompanying drawings, among which:

FIG. 1 is a schematic view in perspective of a machine for implementing the method of the invention;

FIG. 2 is a detail view in perspective ensuring the shaping and welding station of the machine;

FIG. 3 is a detail view in perspective showing the moulding station of the machine;

FIG. 4 is a view similar to FIG. 2 of a variant embodiment of the shaping station;

FIGS. 5 to 8 are views of the shaping and welding station, in cross-section along the plane V of FIG. 4, illustrating the various steps of discharging a tube out of the shaping and welding station;

FIG. 9 is a schematic view in perspective of a machine for implementing the method of the invention, showing more particularly a variant embodiment of the moulding device.

### DETAILED DESCRIPTION OF THE INVENTION

With reference to the figures, the invention relates to a method for manufacturing receptacles, such as flasks or bottles, from a strip Ba of heat-weldable material.

The method comprises the steps of:
heating the tubes separated from each other;
introducing each tube into a mould and blowing a gas therein in order to form the receptacle.

Each tube thus forms a preform that is obtained by implementing the following steps:
cutting an end portion E of the strip Ba in order to form a blank E′ and to shape the blank E′ as a tube in order to have two edges of the blank E′ facing each other;
fixing the two facing edges to each other.

It will be noted that the shaping of the tube is carried out so that the tube T is formed around a central axis aligned with a width 1 of the strip Ba.

This method is for example implemented by means of a machine comprising a frame 0 successively carrying a station 10 for paying out the strip Ba from a reel Bo having a central axis X1, a member 20 for cutting an end portion E of the strip Ba, a member 30 for winding the blank E′ on itself around an axis X2 parallel to the central axis X1 in order to bring two edges of the blank E′ facing each other while forming a tube, a tool 40 for welding the two edges, a member 50 for heating the tube T thus formed, a moulding device 60 for accepting each heated tube T and a device 70 for blowing air into the tube T.

The cutting member 20 is mounted on the frame 0 where the strip Ba enters the winding member 30. The cutting member 20 comprises a bevelled blade 21 mounted opposite an edge of a plate 22 secured to the frame so that the free end E of the strip Ba passes between the blade 21 and the plate 22 in order to enter the winding member 30. The blade 21 is secured to a cylinder (not visible here) moving the blade 21 between a cutting position in which the blade 21 comes in the vicinity of the edge of the blade 22 once an end portion E has been introduced into the winding member 30 in order to form the blank E′, separating said end portion E, by a shearing effect, from the rest of the strip Ba, and a retracted position enabling a new end portion E to be introduced into the winding member 30.

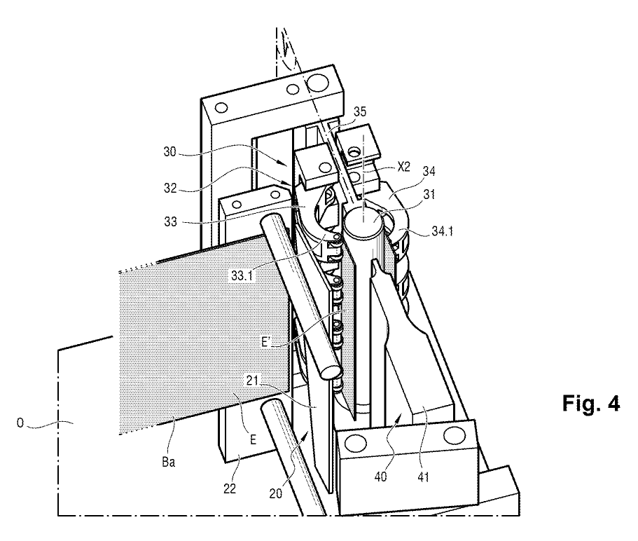

The winding member 30 comprises two mandrels 31 mounted on a movable support 36 in order to bring each mandrel 31 alternately into a shaping position in which the mandrel 31 defines the winding axis X2 and into a discharge position. The winding member 30 also comprises a shaper 32 comprising two jaws 33, 34 and a presser 35 that are carried by a carriage 36 sliding perpendicular to the axis X2 between a position separated from the mandrel 31 to allow the introduction of the end portion E between the mandrel 31 and the shaper 32, and a closed position in which the presser 35 applies the blank E′ against the mandrel 31. The carriage 36 is moved between its two positions by a cylinder 37. The presser 35 is in the form of a bar extending parallel to the axis of the mandrel 31 and opposite a generatrix of the mandrel 31 in the shaping position. The jaws 33, 34 have free edges 33.1, 34.1 extending parallel to the mandrel 31 and which are articulated on the carriage between an open position and a closed position in which the jaws 33, 34 are closed on the mandrel 31 and the free edges 33.1, 34.1 are applied against the wall of the blank E′ at a distance from the edges thereof in order to keep facing each other said edges of the blank E′ then in the form of a tube around the mandrel 31. More precisely, the edges of the blank E′ are here kept in a straddling state. The free edges 33.1, 34.1 are provided with rollers in order not to damage the external surface of the blank E′ during the shaping (what is referred to as the external surface of the blank E′ is the surface that will form the external surface of the tube and therefore of the receptacle once formed). In the variant in FIG. 4, the winding member 30 comprises a single mandrel 31 fixed to the frame 0.

The welding tool 40 comprises an ultrasonic sensor 41 secured to a cylinder 42 mounted on the frame 0 and arranged to move the ultrasonic sensor 41 between a welding position in which the ultrasonic sensor 41 applies the free edges of the blank E′ against each other and against the mandrel 31, thus ending the production of a tube T, and a retracted position in which the ultrasonic sensor 41 is separated from the mandrel 31.

It will be noted that the tube T produced in the winding member 30 has a length equal to the width 1 of the strip Ba and which corresponds here substantially to the height of the receptacle to be obtained.

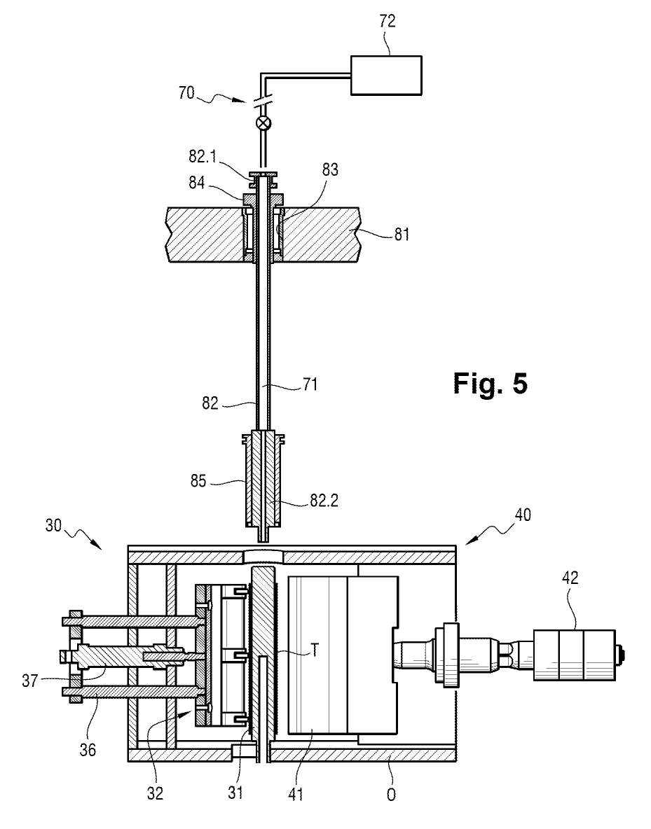

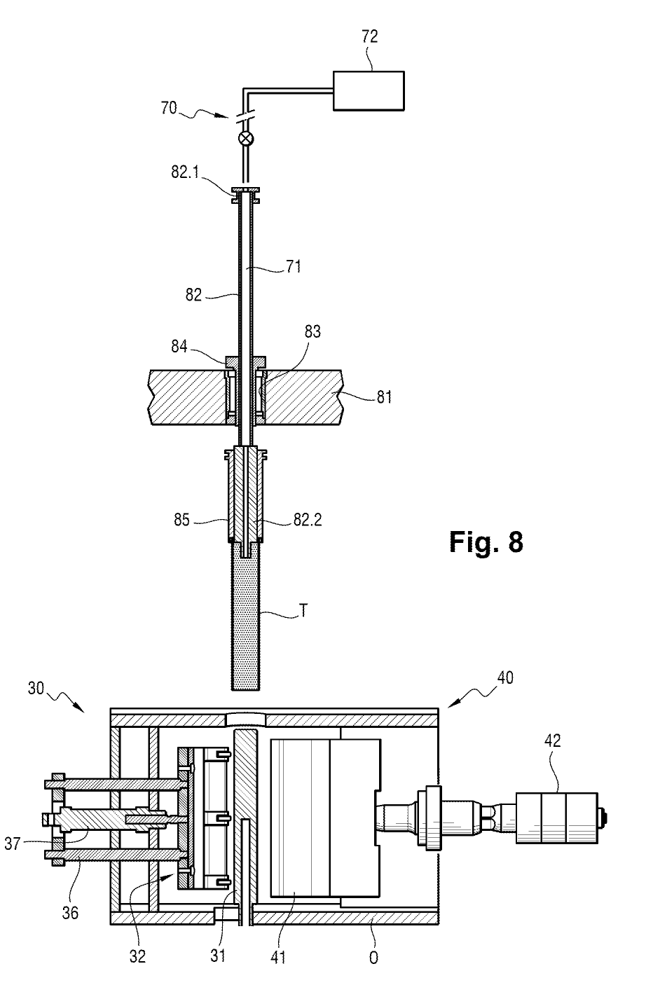

The machine comprises a device 80 for transporting the tubes from the winding member 30 as far as the moulding device 60 passing through the heating member 50. The transport device 80 comprises a platform 81 able to rotate about an axis X3 parallel to the axes X1 and X2. Spindles 82 extend parallel to the winding axis X2 from an external periphery of the platform 81. Each spindle 82 (more clearly visible in FIGS. 5 to 8) is mounted in a bearing 83 pivotably receiving a socket 84 in which the spindle 82 is slidably received in order to allow pivoting of the spindle 82 on itself with respect to the platform 81 and a vertical sliding of the spindle 82 with respect to the platform 81 between a low position and a high position. The top end of the socket 84 is provided with a pinion cooperating with a fixed toothed sector (not shown here) that extends above the platform 81 in order to rotate the spindle 82 when the latter is opposite the heating device 50. The toothed sector may be continuous so that the spindle turns on itself without stopping between the winding member 30 and the moulding device 60, thus allowing uniform heating of the tube T over the entire circumference thereof, or to be interrupted in isolation so that the rotation of the tube T is interrupted over part of its movement between the winding member 30 and the moulding device 60, thus allowing greater heating of certain portions of the circumference of the tube T. It should be noted that the total rotation angle of the tube T during its movement between the winding member 30 and the moulding device 60 will determine the position of the welding of the tube with respect to the mould and therefore with respect to the final form of the receptacle: arrangements would therefore be made for the welding to be positioned in a place that is as convenient as possible either for the causing of the deformation of the tube T or for the aesthetic appearance of the receptacle.

Each spindle 82 comprises a top end portion 82.1 extending above the platform 81 and a bottom end portion 82.2 extending below the platform 81. The top end portion 82.1 is connected to a drive assembly (not shown) comprising a cylinder for driving the spindle 82 in translation between these two positions. The drive assembly 84 thus forms in particular an element for vertical movement of the spindle 82. The bottom end portion 82.2 carries a sleeve 85 mounted for sliding between a position of covering the bottom end portion 82.2 and a position projecting downwards. The bottom end of the sleeve is provided with an element for gripping one end of the tube T. This gripping element comprises here fingers arranged to grip the top end of the wall of the tube T. The fingers are connected to an actuator in order to move them between a position of gripping a tube and a position of releasing a tube.

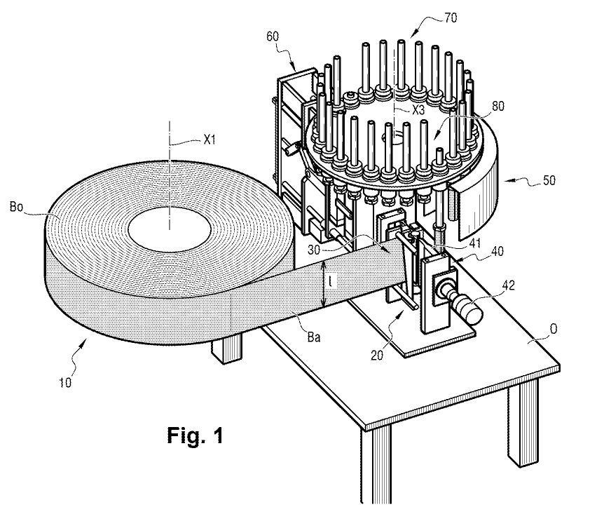

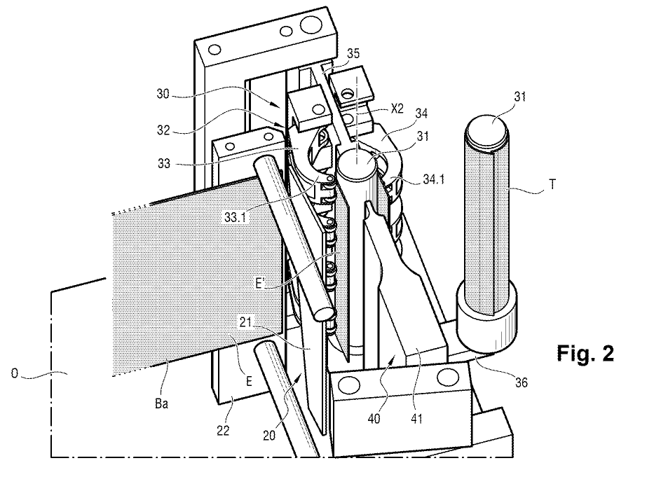

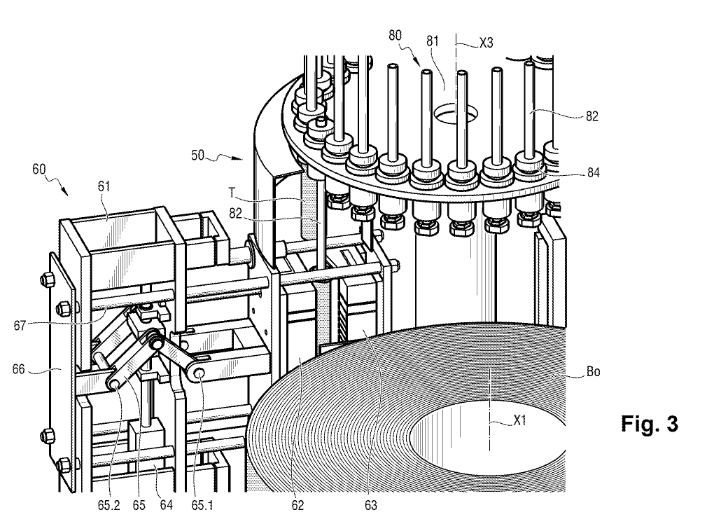

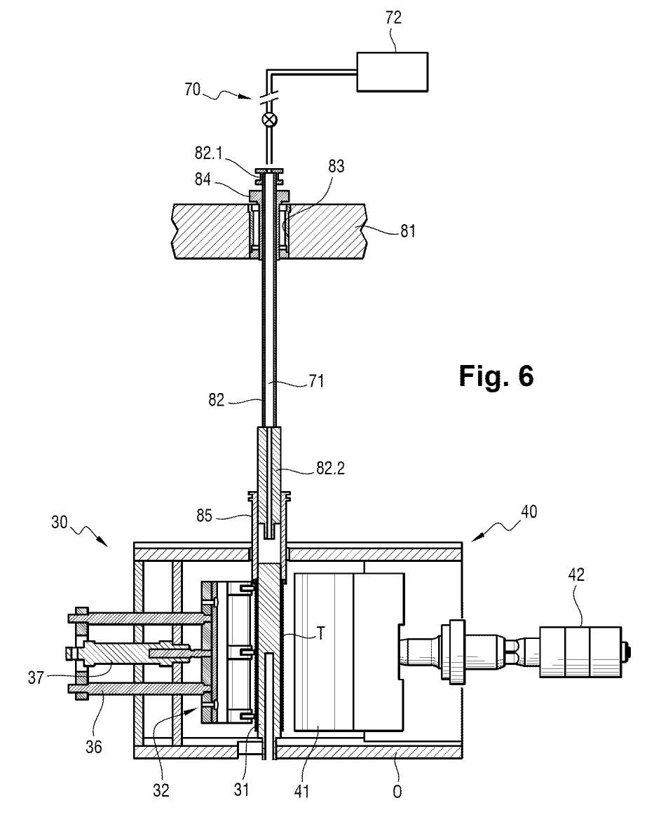

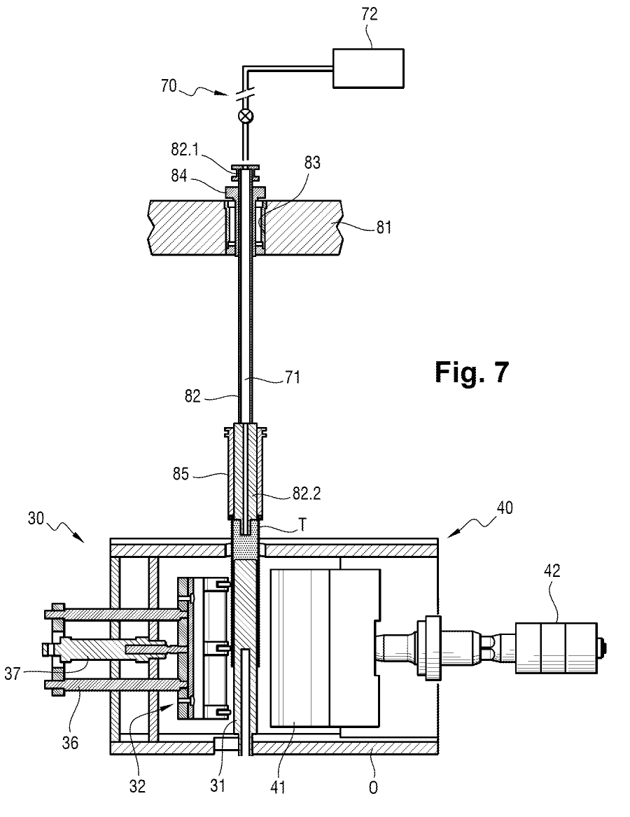

The various vertical positions of the spindles 31 will be explained in relation to FIGS. 5 to 8, knowing that the fact that the winding member 30 comprises two mandrels 1 (FIGS. 1 to 3) or only one (as in FIGS. 4 to 8) has no effect. Each spindle 82 is brought into the low position (visible in FIG. 5) above the mandrel 31 in the discharge position or above the single mandrel 31 since the sleeve 85 is also brought into the low position (visible in FIG. 6) in order to grip the tube T received on the mandrel 31. Once the tube T is gripped, the sleeve 85 is brought into its high position (FIG. 7) and the spindle 82 is brought into the high position in order to release the tube T from the mandrel 31. The platform 81 then pivots in order to bring the tube T into the heating member 50 and then into the moulding device 60. It will be understood that each tube T is extracted through the top of the winding member 30 and is introduced vertically from the top into the moulding device 60.

The heating member 50 comprises radiant elements that are fixed to the frame in an arc of a circle along a path of the tubes T between the winding member 30 and the moulding device 60 when the spindles 82 are in the high position. The radiant elements are here infrared lamps but could be heating elements. The heating member 50 may also comprise nozzles blowing hot air. The heating of the tubes T is thus carried out during a transit time for the tubes T between the winding member 30 and the moulding device 60.

The moulding device 60 comprises a chassis 61 carrying a pair of half-moulds 62, 63 extending respectively outside and inside the path of the spindles 82. The half-moulds 62, 63 are able to move towards each other from an open position in order to be able to close on the tube T transported by a spindle 82. In the closed position, the half-moulds 62, 63 delimit a cavity in the shape of the receptacle to be manufactured. In the open position, the half-moulds 62 and 63 are separated in order to allow the discharge of the receptacle produced. The half-moulds 62, 63 are actuated between their two positions by a cylinder 64, the body of which is secured to the chassis 61 so that the half-mould 62 is positioned between the half-mould 63 and the cylinder 64. The cylinder 64 has a rod that deploys vertically and is connected to the central articulation of a knuckle joint 65, a first end 65.1 of which is connected to the half-mould 62 and opposite a second end 65.2 is connected to a plate 66 that is connected by rods 67 to the half-mould 63. When the rod of the cylinder 64 is retracted, it deploys the knuckle joint 65, the first end 65.1 of which pushes the half-mould 62 and the second end 65.2 of which pushes the plate 66 pulls on the half-mould 63 via the rods 67.

The blowing member 70 comprises pipes 71 each extending in one of the spindles 82 and each having one end connected to a pressurised air circuit 72 and an opposite end pushing on an external surface of the spindle 82.

Naturally, the invention is not limited to the embodiments described but encompasses any variant falling within the field of the invention as defined by the claims.

In particular, the machine may have a structure different from the one described here.

Although here the two edges are fixed by welding, it is possible to fix them by another means and for example by adhesive bonding.

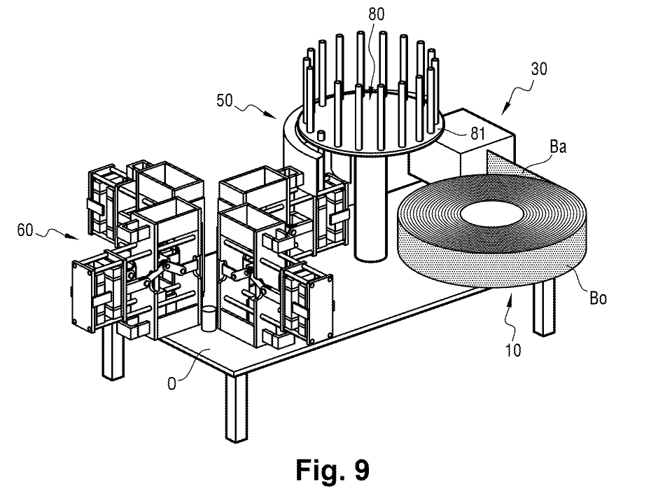

In a variant, as shown in FIG. 9, the moulding device 60 comprises a rotary carousel 68 that is mounted so as to pivot on the frame 0 and which carries here four chassis 61 each provided with a pair of half-moulds 62, 63 and their actuation means. This makes it possible to increase the rate.

The cylinders described are pneumatic cylinders but could be replaced by linear electrical actuators.

Although having here been described in application to a rotary platform machine, the invention is applicable to a linear machine. The tubes are for example supported by a linear conveyor, a chain or the like, disposed so as to move the tubes in front of the heating member.

In a variant, the machine can be provided with blanks precut to a length corresponding to the final length of the tube. The blanks are then brought one by one to the shaping member.

The moulding device may comprise two mould-carrier plates with intermittent movement on two different levels to avoid interference.

The mould may be oriented so that the receptacle has its opening oriented downwards and the blowing device may comprise a rod introduced through the bottom of the tube. The blowing rod may thus be disposed so as to blow either from the bottom or from the top of the mould.

The machine may be arranged to form receptacles with a calibrated neck or not.

The formation as a tube may be carried out by passing the blank between rollers.

The winding may be carried out around an axis parallel to the axis of the reel as described or around an axis perpendicular to the axis of the reel. In another case, it should be noted that the width of the reel determines the maximum diameter of the receptacle that can be obtained. There will therefore be mandrels having diameters corresponding to each receptacle diameter and advantageously the reels will be provided with different widths each corresponding to a mandrel diameter.

The strip may be cut, immediately before it is introduced into the machine, so as to have a width corresponding to the required one or have the required width originally.

The shaping of the tube is carried out by winding the strip portion around a winding axis parallel to a length of the strip.

The method may comprise, after the step of shaping as a tube, a step of cutting the tube in order to form a plurality of tubes of lesser length.

1. A method for manufacturing receptacles, the method comprising the steps of:
heating tubes separate from each other, each tube being obtained by shaping at least one blank as a tube in order to have two edges of the blank facing each other and fixing the two facing edges to each other;
introducing each tube into a mould and blowing a gas therein in order to form the receptacle.

2. A method according to claim 1, in which the shaping is carried out by winding the blank around a mandrel.

3. A method according to claim 1, in which the blank is a portion of a strip payed out from a reel having a central axis.

4. A method according to claim 3, in which the shaping as a tube is carried out so that the tube has a central axis aligned with a width of the strip.

5. A method according to claim 3, comprising, before the step of shaping as a tube, a step of cutting the strip in order to separate the blank therefrom.

6. A method according to claim 3, in which the shaping of the tube is carried out by winding the strip portion around a winding axis parallel to a length of the strip.

7. A method according to claim 6, comprising, after the step of shaping as a tube, a step of cutting the tube in order to form a plurality of tubes of lesser length.

8. A method according to claim 1, in which the two edges are fixed by welding.

9. A method according to claim 1, in which the heating is carried out for the time taken for the tube to pass between a station for shaping as a tube and the mould.

10. A machine for manufacturing receptacles, comprising successively:
a station forming tubes from at least one blank, with a member for winding a blank on itself around a winding axis in order to bring two edges of the blank facing each other, and a tool for welding the two edges;
a member for heating the tubes;
a blowing station with at least one mould for accepting the heated tubes and a device for blowing gas into each tube; and
a device for transporting tubes between the tube-formation station and the blowing station, and in the heating member.

11. A machine according to claim 10, in which the winding member comprises a mandrel defining the winding axis and a shaper comprising two jaws that have free edges extending parallel to the mandrel and which are articulated between an open position making it possible to introduce the blank between the shaper and the mandrel and a closed position in which the free edges of the jaws of the shaper hold the edges of the blank facing each other.

12. A machine according to claim 10, comprising spindles that extend parallel to the winding axis from the transport device moving each spindle between a position for picking up the tube in the winding member and a position of introducing the tube into the mould.

13. A machine according to claim 12, in which the transport device is a rotary plate.

14. A machine according to claim 12, in which the transport device comprises an element for the vertical movement of the spindles between a low position of taking up the tube on the mandrel and the introduction of the tube into the mould, and a high transport position.

15. A machine according to claim 14, in which each spindle has an end provided with an element for gripping one end of the tube.

16. A machine according to claim 12, in which the heating member extends along a path for the spindles between the position for taking up the tube in the winding member and the position for introducing the tube into the mould.

17. A machine according to claim 12, in which the blowing member comprises a pipe extending in the spindle and having one end connected to a pressurised air circuit and an opposite end emerging on an external surface of the spindle.
